(19) United States
(12) Patent Application Publication
(10) Pub. No.: US 2013/0027221 A1
(43) Pub. Date: Jan. 31, 2013

(54) Warning system for an intersection

(71) Applicants: Ivay Johnson, Hustonville, KY (US); Jack Judy, Hustonville, KY (US)

(72) Inventors: Ivay Johnson, Hustonville, KY (US); Jack Judy, Hustonville, KY (US)

(21) Appl. No.: 13/136,370

(22) Filed: Jul. 30, 2011

(51) Int. Cl. G08G 1/00

(52) U.S. Cl. 340/902

(57) ABSTRACT

A warning system for pedestrian and vehicular traffic that can warn pedestrians and drivers of an emergency vehicle that is approaching a road intersection. The current warning system is multimodal and uses different modes and colors to indicate the type of approaching emergency vehicle. Flashing devices are mounted to fixtures associated with currently available traffic light configurations.

### BACKGROUND OF THE INVENTION

1. Field of the Invention

In the most general sense, the present invention relates to warning systems for road intersections. The present warning system for pedestrian and vehicular traffic can warn pedestrians and drivers of a rapidly approaching emergency vehicle. The current warning system is multimodal and is capable of warning both pedestrians and drivers of the type of approaching emergency vehicle. Flashing lighting devices of the current invention can be mounted to fixtures associated with currently available traffic light configurations. A receiver and controller associated with one of the lighting devices controls activation of all lighting devices positioned about the road intersection while a transmitter carried by the emergency vehicle transmits the signal to the receiver. The frequency and signal utilized by the current warning system are independent of any other signals associated with commercially available traffic light configurations.

2. Description of the Previous Art

Any discussion of references cited in this Description of the Previous Art merely summarizes the disclosures of the cited references and Applicant makes no admission that any cited reference or portion thereof is relevant prior art. Applicants reserve the right to challenge the accuracy, relevancy and veracity of the cited references.

1) U.S. Pat. No. 5,889,475—Klosinski, et al. enables a warning system for emergency vehicles. Column 4, lines 18 through 21, reads, “Referring now to FIG. 2, we see a modified traffic signal indicator 4 having a red light 7, yellow light 6, and green light 5 as well as an audible warning indicator 8, and a visual warning indicator 9 affixed thereon. The specific positioning of these indicators in the Figure is not important, just that the visual and audible indicator are able to be seen and heard respectively. In the figure, the audible warning indicator 8 is shown giving off an audible signal 16 to warn pedestrians and vehicles 13 of the approaching emergency vehicle 10. The audible and visual indicators 8 and 9 could possibly be eliminated whereupon the receiver 2 will have circuitry that will cause all of the lights of the traffic signal device 4 to flash red thereby causing all traffic to stop at the intersection 12.”

Among other things, Klosinski does not teach or suggest any lighting device other than the traffic signal, first and second flashing modes for a flashing visible warning, an analog frequency carrying an activation code for activating first and second flashing modes or that an emergency vehicle's transmitter's signal can activate the flashing visible warning device from as far away as about 305 meters from the flashing warning device.

2) U.S. Pat. No. 6,441,749—Edwards enables an interactive automated traffic control system. Column 2, lines 16 through 32, reads, “FIG. 1 shows an exemplary embodiment of the interactive automated traffic control system of the present invention generally designated 10. Interactive automated traffic control system 10 includes an electronic warning signal assembly including a warning light unit generally designated 14 having an AC to DC transformer 16, a receiver circuit 18 and a timer circuit 20 along with a transmitter 22 which is carried in the emergency vehicle. Receiver circuit 18 receives a signal from transmitter 22 to activate the warning light unit 14 to assist emergency vehicles in passing safely through an intersection. A warning light unit is attached to an existing traffic light signal 24 shown in FIG. 2. Once the emergency vehicle has passed the intersection, the transmitter sends a reset signal to the receiver 18 which activates a timer 20 which after the set time period has elapsed deactivates the warning light unit 14.”

Among other things, Edwards does not teach or suggest a lighting device that has first and second flashing modes for a flashing visible warning, an analog frequency carrying an activation code for activating first and second flashing modes or that an emergency vehicle's transmitter's signal can activate the flashing visible warning device from as far away as about 305 meters from the flashing warning device.

3) U.S. Pat. No. 6,556,148—Ellis enables an emergency light flashing mechanism. Column 15, lines 44 through 54, reads, “In addition to control lights 20 mounted at one or more intersection, emergency light flashing mechanisms 22 may be mounted at one or more intersections. Preferably, there are two sets of lights at each of the intersections requiring light regulation, with one set of lights being the control lights 20 and with the other set of lights being the emergency flashing light mechanisms 22. Or, if desired, the emergency flashing light mechanism 22 may be a mechanism in each of the control lights 20 which controls such lights 20 so as to, for example, flash the lights 20.”

Among other things, Ellis does not teach or suggest a lighting device that has first and second flashing modes for a flashing visible warning, an analog frequency carrying an activation code for activating first and second flashing modes or that an emergency vehicle's transmitter's signal can activate the flashing visible warning device from as far away as about 305 meters from the flashing warning device.

4) U.S. Pat. No. 6,940,422—Bachelder, et al. enables an emergency vehicle traffic signal preemption system. Column 3, lines 64 through Column 4, line 8 read, “The system transmits a signal causing all traffic lights at an intersection to switch to “red” thus stopping all traffic in all directions. In addition, the display panels flash a relatively large “emergency vehicle” therein with a graphic display indicating the lane and direction of traffic taken by an emergency vehicle. The range of the infrared transmitter can be as much as 1,000 feet allowing sufficient time to clear the intersection. The new improved system utilizes a wide area wireless RF two-way communication link between emergency vehicles and intersections. This method is more reliable and not affected by weather, lack of line of sight, range limitation or obstructions.”

Among other things, Bachelder does not teach or suggest a lighting device that has first and second flashing modes for a flashing visible warning or an analog frequency carrying an activation code for activating first and second flashing modes.

5) U.S. Pat. No. 6,980,125—Barber enables a warning system for alerting pedestrians and passenger vehicle operators of an approaching emergency vehicle. Column 3, lines 6 through 51, reads, “FIG. 1 illustrates a perspective view of the warning light system 10, attached to an existing traffic light pole 22. The traffic light pole 22 also has two existing traffic light assemblies 20 attached thereunto, each having a red light 25, a green light 21, and a yellow light 23, for indicating to pedestrians and passenger vehicles whether to stop, proceed, or proceed with caution into an intersection. The warning light system 10 comprises a warning light assembly 12 which is enclosed by a warning light housing 12 H, and an audio sensor unit 14 enclosed within an audio sensor unit housing 14 H. The warning light housing 12 H has an upper surface 12 U, a lower surface 12 L, two opposing side surfaces 12 S, a front surface 12 F, and a rear surface. Similarly, the audio sensor unit housing 14 H has an upper surface 14 U, a lower surface 14 L, two opposing side surfaces 14 S, a front surface 14 F, and a rear surface. The upper surface 14 U of the audio sensor unit housing 14 H is attached to the lower surface 12 L of the warning light housing 12 H. The warning light housing 12 H contains a white light 16 and a blue light 18 and has two substantially rectangular openings 16 A and 18 A which extend fully through the front surface 12 F of the warning light housing 12 H, which allow for unimpeded viewing of the white light 16 and the blue light 18. Each of the rectangular openings 16 A and 18 A are preferably covered by a sturdy, transparent, glass or plastic lens, for protection of the lights 16, 18. The audio sensor unit housing 14 H encloses an audio sensor which detects ambient sound. The warning light housing 12 H additionally contains a control unit which isolates frequencies and sound patterns associated with the siren of an emergency vehicle, and outputs the isolated signal, thereby causing the white light 16 and the blue light 18 to flash alternately and repeatedly, as will be described hereinafter.”

Among other things, Barber does not teach or suggest a lighting device that has first and second flashing modes for a flashing visible warning, an analog frequency carrying an activation code for activating first and second flashing modes or that an emergency vehicle's transmitter's signal can activate the flashing visible warning device from as far away as about 305 meters from the flashing warning device.

6) U.S. Pat. No. 7,884,738—Pappas, et al. enables am emergency traffic light system. Column 3, lines 6 through 51, reads, “FIG. 1 illustrates a perspective view of the warning light system 10, attached to an existing traffic light pole 22. The traffic light pole 22 also has two existing traffic light assemblies 20 attached thereunto, each having a red light 25, a green light 21, and a yellow light 23, for indicating to pedestrians and passenger vehicles whether to stop, proceed, or proceed with caution into an intersection. The warning light system 10 comprises a warning light assembly 12 which is enclosed by a warning light housing 12 H, and an audio sensor unit 14 enclosed within an audio sensor unit housing 14 H. The warning light housing 12 H has an upper surface 12 U, a lower surface 12 L, two opposing side surfaces 12 S, a front surface 12 F, and a rear surface. Similarly, the audio sensor unit housing 14 H has an upper surface 14 U, a lower surface 14 L, two opposing side surfaces 14 S, a front surface 14 F, and a rear surface. The upper surface 14 U of the audio sensor unit housing 14 H is attached to the lower surface 12 L of the warning light housing 12 H. The warning light housing 12 H contains a white light 16 and a blue light 18 and has two substantially rectangular openings 16 A and 18 A which extend fully through the front surface 12 F of the warning light housing 12 H, which allow for unimpeded viewing of the white light 16 and the blue light 18. Each of the rectangular openings 16 A and 18 A are preferably covered by a sturdy, transparent, glass or plastic lens, for protection of the lights 16, 18. The audio sensor unit housing 14 H encloses an audio sensor which detects ambient sound. The warning light housing 12 H additionally contains a control unit which isolates frequencies and sound patterns associated with the siren of an emergency vehicle, and outputs the isolated signal, thereby causing the white light 16 and the blue light 18 to flash alternately and repeatedly, as will be described hereinafter.”

Among other things, Barber does not teach or suggest a lighting device that has first and second flashing modes for a flashing visible warning, an analog frequency carrying an activation code for activating first and second flashing modes or that an emergency vehicle's transmitter's signal can activate the flashing visible warning device from as far away as about 305 meters from the flashing warning device.

### SUMMARY OF THE INVENTION

The present invention relates to a warning system for pedestrian and vehicular traffic where the warning system visually warns pedestrians and drivers of a rapidly approaching emergency vehicle. The current warning system includes at least first and second flashing modes for flashing the visible warning. By way of illustration, a first flashing mode can indicate an approaching fire truck or ambulance while a second flashing mode can indicate an approaching police vehicle. Other multimodal embodiments of the present invention can include more than two flashing warning modes. For example, select preferred embodiments of the current invention can include a brief flashing mode cautioning that other flashing modes are about to activate.

Lighting devices of the current invention flash the warning signals and can be mounted to fixtures, such as poles, associated with currently available traffic light configurations. A receiver is associated with one of the lighting devices of the present invention and is activated by a transmitter carried by the emergency vehicle to flash the warning of the approaching emergency vehicle. The signal received by the receiver and controller controls activation and deactivation of all lighting devices positioned about the road intersection.

An aspect the present invention is to provide a visual warning device capable of warning pedestrians and vehicles of an approaching emergency vehicle, where the visual warning device is compatible with commercially available traffic light configurations that currently control pedestrian and vehicular traffic at a road intersection.

Still another aspect of the present invention is to provide a transmitter and a receiver operating on a FCC approved analog frequency.

Yet another aspect of the present invention is to provide a warning system that does not interrupt the normal operation of the commercially available traffic light configurations.

Still another aspect of the present invention is to provide a lighting device that has zones of different hues.

It is another aspect of the present invention to provide lighting devices that are powered by the power supply supplying the commercially available traffic light configuration or by solar energy.

Still another aspect of the present invention to provide a receiver with an antenna for detecting as little as about 0.2 millivolt associated with reception of the single preselected analog FCC approved frequency from a distance of up to about 305 meters.

Yet another aspect of the present invention is to provide a transmitter signal carrying an activation code that indicates the type of emergency vehicle from which the signal is broadcast.

Still another aspect of the present invention is to provide an embodiment that briefly flashes a yellow hue indicating that an emergency vehicle is approaching the intersection and the warning system will soon activate a flashing mode identifying the type of emergency vehicle that is approaching the intersection.

It is still another aspect of the present invention to provide a receiver that does not activate the current warning system for pedestrian and vehicular traffic until predetermined voltage conditions are achieved.

Yet another aspect of the present invention is to provide a warning system that is activated after the receiver exceeds a predetermined threshold of potential associated with the single preselected FCC approved analog frequency radio frequency transmission.

Still another aspect of the present invention is to provide an embodiment that includes a threshold determiner that preventing activation of the warning system until the emergency vehicle's transmitter has reached a preselected distance from the receiver.

An embodiment of the present invention can be described as a visible warning system for a road intersection, wherein the visible warning system is capable of indicating an emergency vehicle is proximate a commercially available traffic light configuration controlling pedestrian and vehicular traffic associated with the road intersection; the visible warning system comprising: a) a plurality of LED units positioned about the road intersection and visible to the pedestrian and vehicular traffic, wherein the LED units: i) on activation, flash visible warnings comprising at least two distinct colors for identifying a specific type of the emergency vehicle and/or a different color from the at least two distinct colors for indicating the visible warning system is activating; and ii) are powered by a power supply also supplying the commercially available traffic light configuration; b) a transmitter carried by an emergency vehicle and powered by the emergency vehicle's electrical system, wherein, upon activation of the transmitter, transmission of a single preselected FCC approved analog frequency carrying a predetermined activation code is broadcast away from the emergency vehicle, and wherein the classification of the emergency vehicle determines the predetermined activation code; c) a receiver powered by the power supplying the commercially available traffic light configuration and/or a solar Nnel and an energy storage unit combination, wherein the receiver is synchronized to the single preselected FCC approved analog frequency and operates independently of the commercially available traffic light configuration such that the receiver does not alter operation of the commercially available traffic light configuration and the commercially available traffic light configuration does not alter operation of the receiver, wherein the receiver comprises: i) a weather resistant housing; ii) an antenna for detecting as little as about 0.2 millivolt associated with reception of the single preselected FCC approved analog frequency; iii) a first relay for activating the plurality of LED units to flash in a first mode, wherein the first mode includes a first color and a second color; iv) a second relay for activating the plurality of LED units to flash in a second mode, wherein the second mode excludes either the first color or the second color and utilizes a third color; v) a threshold determiner preventing activation of any of the relays until the emergency vehicle's transmitter has reached a preselected distance from the receiver; vi) optionally, a third relay for activating the plurality of LED units to flash a third mode comprising a different color than the first mode or the second mode; and vii) a controller energizing one or more of the relays on detection of the predetermined code and after a predetermined threshold of potential associated with the single preselected FCC approved analog frequency radio frequency broadcast by the emergency vehicle's transmitter is exceeded; and d) one or more lines connecting the controller to each of the plurality of LED units.

Another embodiment of the present invention can be described as a visible warning system capable of generating a multimodal visible flash to warn pedestrians and vehicles that an emergency vehicle is approaching an intersection; the visible warning system comprising: a) a plurality of lighting devices positioned about the intersection with a commercially available traffic light configuration, wherein each of the lighting devices comprises at least three zones of lights having distinct hues and is powered by a power supply supplying the commercially available traffic light configuration, and wherein on activation, the lighting devices flash at least two distinct hues for identifying a specific type of the emergency vehicle; b) a transmitter carried by an emergency vehicle and powered by the emergency vehicle's electrical system, wherein, upon activation of the ransmitter, transmission of a single preselected FCC approved analog frequency carrying a predetermined activation code is broadcast away from the emergency vehicle, and wherein the classification of the emergency vehicle determines the predetermined activation code; c) a receiver powered by the power supplying the commercially available traffic light configuration and/or a solar panel and an energy storage unit combination, wherein the receiver is synchronized to the single preselected FCC approved analog frequency and operates independently of the commercially available traffic light configuration such that the receiver does not alter operation of the commercially available traffic light configuration and the commercially available traffic light configuration does not alter operation of the receiver, wherein the receiver comprises: i) a weather resistant housing; ii) an antenna for detecting as little as about 0.2 millivolt associated with reception of the single preselected FCC approved analog frequency; iii) a first relay for activating the plurality of lighting devices to flash a first hued zone of and a second hued zone; iv) a second relay for activating the plurality of lighting devices to flash a third hued zone and either the first hued zone or the second hued zone; v) optionally, a third relay for activating the plurality of lighting devices to flash a hued zone other than the first, second or third zones; and vi) a controller energizing one or more of the relays on detection of the predetermined code and after a predetermined threshold of potential associated with the single preselected FCC approved analog frequency radio frequency broadcast by the emergency vehicle's transmitter is exceeded; and d) one or more lines connecting the receiver to each of the lighting devices.

Another embodiment of the present invention can be described as a visible warning system associated with a commercially available traffic light configuration controlling pedestrian and vehicular traffic about an intersection, wherein the visible warning system is capable of generating multimodal visible flashes to warn the pedestrian and vehicular traffic that an emergency vehicle is approaching the intersection; the visible warning system comprising: a) a plurality of colored lights units positioned on one or more fixtures of the commercially available traffic light configuration, wherein the plurality of colored lights units are additional to any lighting device customarily accompanying the commercially available traffic light configuration; b) a transmitter carried by an emergency vehicle and powered by the emergency vehicle's electrical system, wherein, upon activation of the transmitter, transmission of a single preselected FCC approved analog frequency carrying a predetermined activation code is broadcast away from the emergency vehicle, and wherein the classification of the emergency vehicle determines the predetermined activation code; c) a receiver powered by the power supplying the commercially available traffic light configuration and/or a solar panel and an energy storage unit combination, wherein the receiver is synchronized to the single preselected FCC approved analog frequency and operates independently of the commercially available traffic light configuration such that the receiver does not alter operation of the commercially available traffic light configuration and the commercially available traffic light configuration does not alter operation of the receiver, wherein the receiver comprises: i) a weather resistant housing; ii) a controller for detecting the predetermined code such that after a predetermined threshold of potential associated with the single preselected FCC approved analog frequency radio frequency broadcast by the emergency vehicle's transmitter is exceeded the controller activates the plurality of colored lights units to flash a first predetermined pattern or a second predetermined pattern, wherein the flashing predetermined patterns are determined by the predetermined activation code, and d) one or more lines connecting the controller to each of the colored light units.

It is the novel and unique interaction of these simple elements which creates the methods, within the ambit of the present invention. Pursuant to Title 35 of the United States Code, descriptions of preferred embodiments follow. However, it is to be understood that the best mode descriptions do not limit the scope of the present invention.

### BRIEF DESCRIPTION OF THE DRAWINGS

FIG. 1 is a frontal view of an embodiment of a lighting device within the scope of the present invention.

FIG. 2 is a perspective view that shows a lighting device attached to a fixture associated with road intersection.

FIG. 3 is a plan view of a road intersection.

FIG. 4 is a perspective of a receiver within the scope of the present invention.

FIGS. 5 and 5A are diagrammatic representations of a preferred embodiment of a receiver and controller within the scope of the present invention.

FIG. 6A is a plan representation of an intersection with the emergency vehicle approaching the traffic light.

FIG. 6B is a plan representation of an intersection with the emergency vehicle (600) that has cleared the intersection.

### DESCRIPTION OF THE PREFERRED EMBODIMENTS

Although the disclosure hereof is detailed to enable those skilled in the art to practice the invention, the embodiments published herein merely exemplify the present invention.

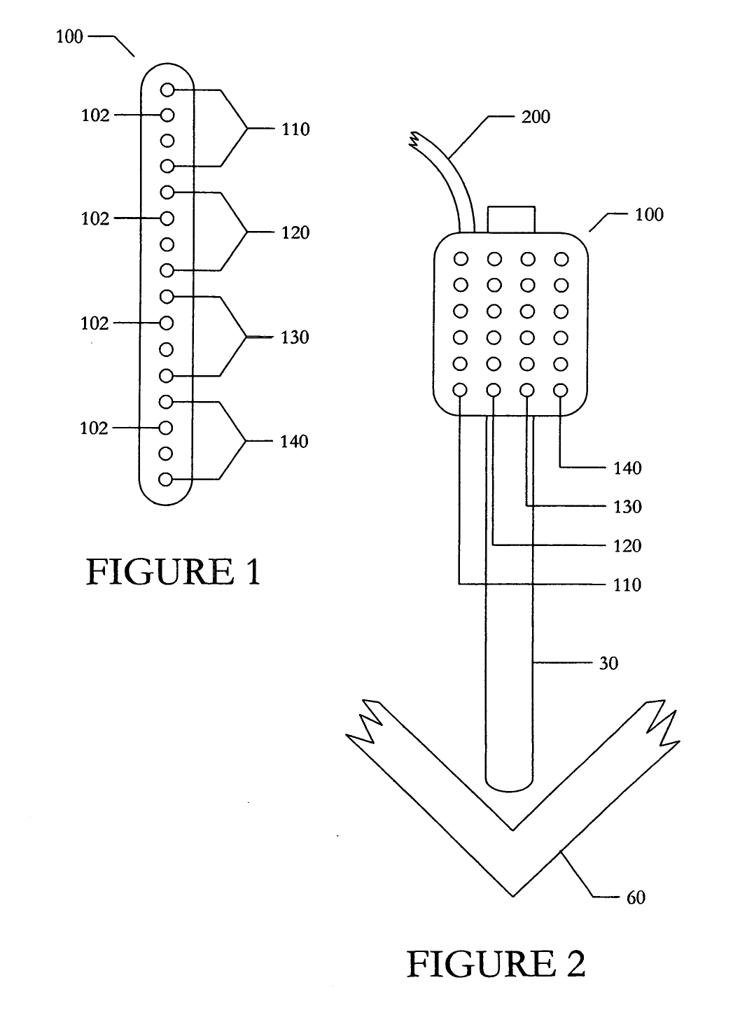

FIG. 1 is a frontal view of an embodiment of a lighting device (100) within the scope of the present invention. Select preferred embodiments of lighting device are equipped with a plurality of LEDs (102). By way of illustration, LEDs (102) can be segregated into a first zone (110) of red lights, a second zone (120) of white lights, a third zone of (130) of blue lights a third zone (140) of yellow lights. Within the ambit of the current invention and when engineering parameters require, lighting device (100) can utilize more than four colors and four zones. Although not shown in FIG. 1, lighting device (100) is provided with commercially available couplers for attaching lighting device (100) to fixtures proximate a road intersection.

FIG. 2 is a perspective view that shows lighting device (100) attached to fixture (30) associated with road intersection (60). As shown in the FIG. 2 preferred embodiment, fixture (30) is a pole associated with a commercially available traffic light configuration capable of controlling pedestrian and vehicular traffic approaching road intersection (60). In other preferred embodiments of the current invention, fixture (30) can be any structure that has a face capable of supporting lighting device (100) so that it is visible to pedestrian and vehicular traffic proximate road intersection (60). Among other things, conduit (200) carries a branch line from the power supply providing power to the commercially available traffic light configuration for supplying power to lighting device (100). As shown in FIG. 2, lighting device (100) includes a plurality of LEDs segregated into to color zones (110, 120, 130 and 140).

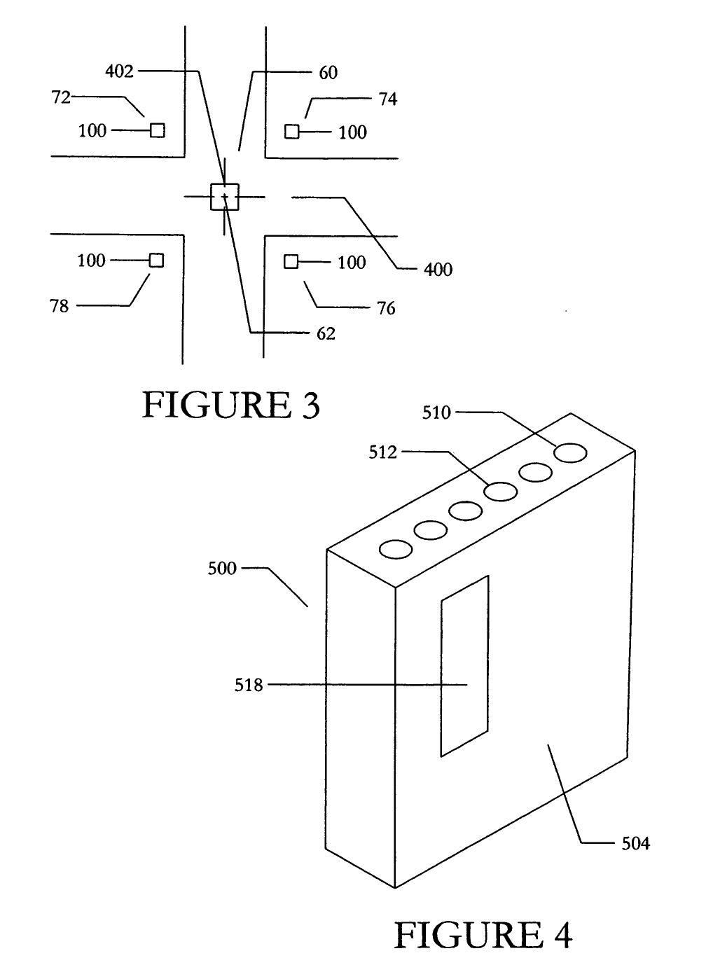

FIG. 3 is a plan view of road intersection (60). Commercially available traffic configuration (400) includes traffic light (402) positioned above the center (62) of road intersection (60). As shown in FIG. 3, road intersection (60) has four corners (72, 74, 76 and 78) with a lighting device (100) positioned proximate each of the four corners (72, 74, 76 and 78). Although FIG. 3 depicts road intersection (60) with four corners (72, 74, 76 and 78), the current invention is functional with any type of road intersection, including road intersections that have from one to five or more corners.

FIG. 4 is a perspective of receiver (500) within the scope of the present invention. Receiver (500) is provided with water resistant housing (504). Depending on preselected engineering parameters, receiver (500) can be located within lighting device (100) or attached to the exterior of lighting device (100). Select preferred embodiments of receiver (500) include solar panel (518) and energy storage device (not shown in this view) combination for powering receiver (500) while other select preferred embodiments of receiver (500) include electrical receptacles (510) for receiving power from power lines (not shown in this view). Within the scope of the current invention, only one of the lighting devices (100) proximate road intersection (60) is provided with receiver (500). A plurality of connectors (512) connectable with lines (not shown in this view) is provided for controlling communications to the remainder of the lighting devices (100) associated with road intersection (60).

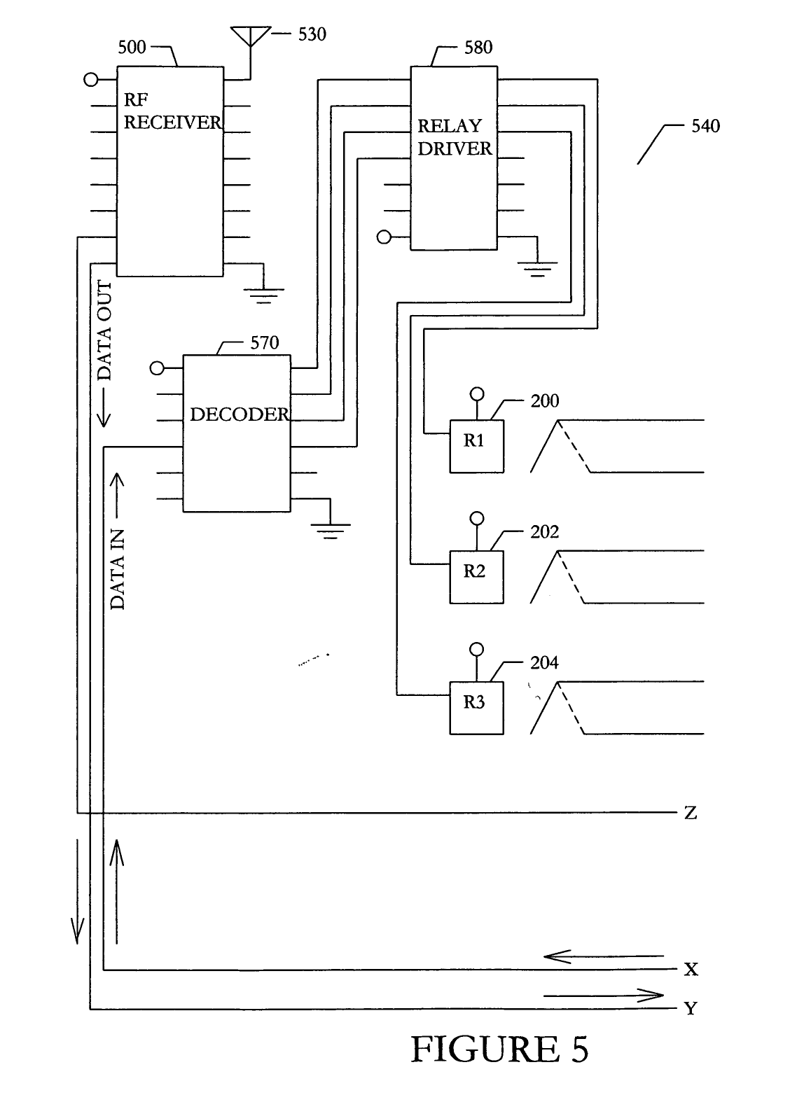

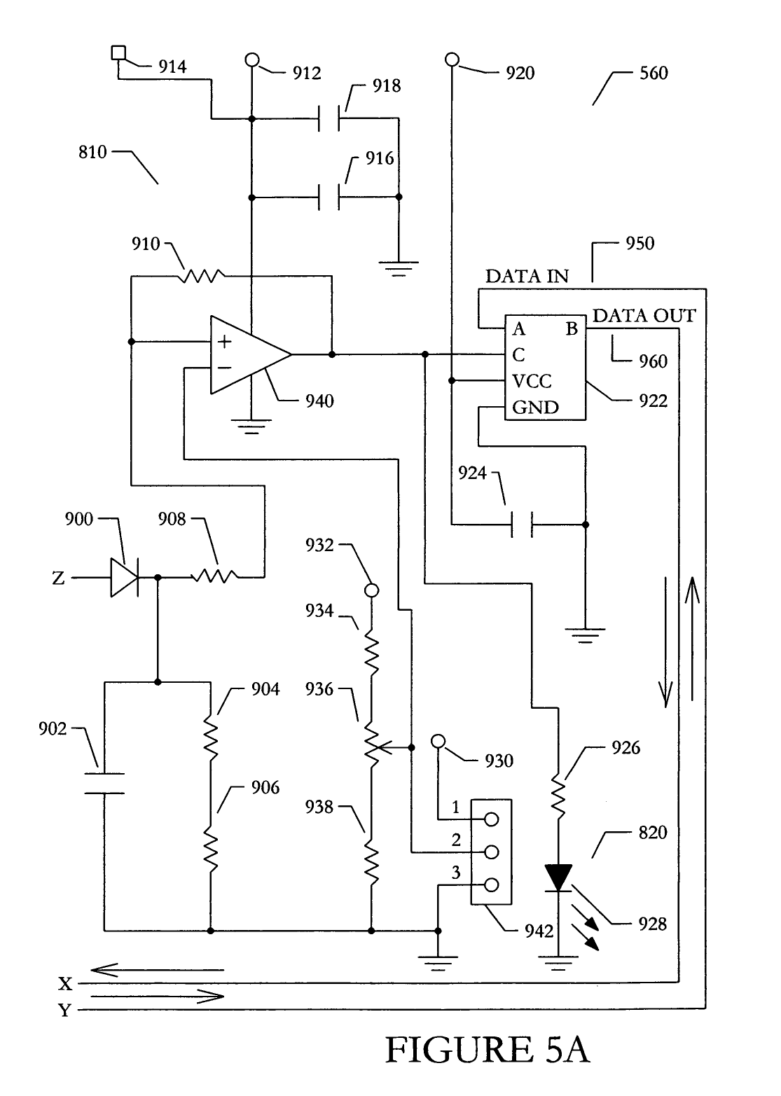

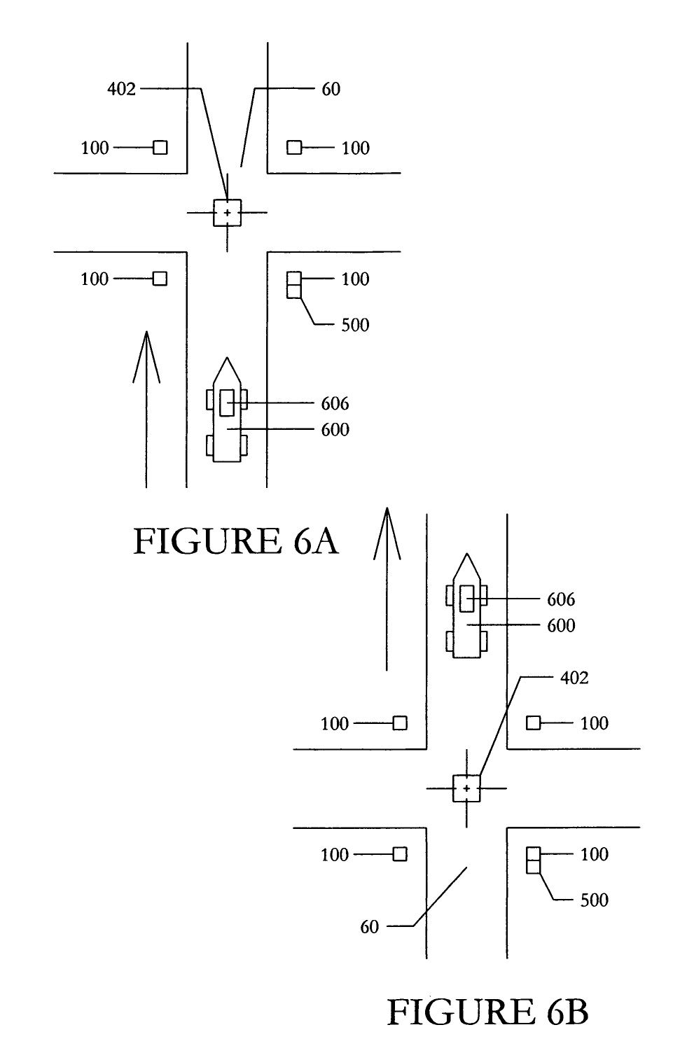

FIGS. 5 and 5A are diagrammatic representations of a preferred embodiment of a receiver (500) and controller (540) for operation at a preselected FCC approved analog frequency, such as 433 megahertz. From a distance of up to about 305 meters, antenna (530) of receiver (500) is capable of detecting as little as about 0.2 millivolt transmission from the transmitter carried by an emergency vehicle. With reference to FIGS. 5, 5A, 6A and 6B, as emergency vehicle's (600) transmitter (606) moves in closer proximity to receiver (500), controller (540) can detect up to about 2 volts or more of potential associated with the radio frequency transmitted by emergency vehicle's (600) transmitter (606).

In select preferred embodiments, depending on the placement of receivers (500) about intersections (60) and the locations of intersections (60), controllers (540) of receivers (500) are preset not to activate until a predetermined condition such as a threshold of detected voltage is exceeded. By way of illustration, receivers (500) located in a rural setting can be preset to activate controller (540) to energize one or more relays (200, 202 or 204) when controller (540) detects as little as about one millivolt. Receivers (500) located in an urban setting can be preset to not energize one or more relays (200, 202 or 204) until sufficient voltage to exceed the threshold of received signal strength circuit (560) of controller (540) is achieved. Among other things, controller (540) also includes decoder (570) and relay driver (580). Data inputs and data outputs acceptable in the art interconnect receiver (500), controller (540) and relays (200, 202 and 204).

A preferred embodiment of received signal strength circuit or threshold determiner (560) of the current invention includes, among other things, peak detector (800), comparator (810) and LED (820). Activation of LED (820) indicates that the current invention is operative. When the predetermined detected voltage is exceeded, comparator (810) initiates activation of decoder (570) and relay driver (580). Select preferred embodiments of comparator (810) include push-pull comparator circuits with hysteresis build option while select preferred embodiments of peak detector (800) include a two second time constant.

As shown in FIG. 5, among other things, received signal strength circuit or threshold determiner (560) includes the following interconnected components: diode (900), resistor (908), resistor (910), voltage collector (912), test point (914), capacitor (916), capacitor (918), voltage collector (920), board (922), capacitor (924), resistor (926), diode (928), voltage collector (930), header (942), voltage collector (932), resistor (934), resistor (936), resistor (938) and amplifier (940). Data input (950) receives data from receiver (500) and data output (960) forwards data to decoder (570).

Received signal strength circuit or threshold determiner (560) of controller (540) is used to preset the distance between transmitter (606) and receiver (500) at which the emergency vehicle's broadcasted radio frequency transmission will activate controller (540) to operate decoder (570) and relay driver (580). Controller (540) is capable of preventing lighting devices (100) not associated with emergency vehicle's (600) immediate route of travel from being activated by the emergency vehicle's (600) radio frequency transmission broadcast by transmitter (606). Select embodiments of received signal strength circuit (560) cause relay driver (580) to continue to activate relays (200, 202 or 204) and color zones (110, 120, 130 and/or 140) for a period of about two seconds after transmitter's (606) radio frequency transmission has ceased to exceed the preset voltage threshold of controller (540). By way of example and not limitation, detection of a two volt radio frequency, transmission from transmitter (606) can activate controller (540) to energize one or more relays (200, 202 or 204) from a distance of about 30 meters, whereas detection of a one volt radio frequency transmission from transmitter (606) could activate controller (540) to energize one or more relays (200, 202 or 204) from a distance of about 100 meters and detection of about a two millivolt radio frequency transmission from transmitter (606) could activate controller (540) to energize one or more relays (200, 202 or 204) from a distance of about 200 meters. Although a plurality of relays (200, 202 or 204) for activating color zones (110, 120, 130 and/or 140) is shown in FIG. 5, in other preferred embodiments of the current invention, the combination of decoder (570), relay driver (580) and a single relay can activate color zones (110, 120, 130 and/or 140) of lighting devices (100).

Antenna (530) receives the potential associated with the FCC approved analog frequency and decoder (570) of controller (540) detects the activation code carried by the FCC approved analog frequency. The encoded code or codes in the FCC approved analog frequency transmission from transmitter (606) determines whether first relay (200), second relay (202) or for select preferred embodiments of the present invention first relay (200) and third relay (204) or second relay (202) and third relay (204) are activated. By way of illustration, energizing first relay (200) causes zones (110 and 120) of lighting device (100) to flash while activation of second relay (202) causes zones (120 and 130) of lighting device (100) to flash. Depending on the number of zones of LEDs (102) carried by lighting device (100), more than two relays can be incorporated into the present invention. By way of illustration, select preferred embodiments energize third relay (204) for a few seconds prior to activation of either first relay (200) or second relay (202). In select preferred embodiments, energizing third relay (204) causes color zone (140) of lighting device (100) to flash a yellow warning indicating that current warning system is preparing to signal the type of emergency vehicle (600) approaching intersection (60).

FIG. 6A is a plan representation of intersection (60) with emergency vehicle (600) approaching traffic light (402) and FIG. 6B is a plan representation of intersection (60) with emergency vehicle (600) that has cleared intersection (60). As previously indicated, emergency vehicle (600) carries transmitter (606) that on activation broadcasts an FCC approved analog frequency that includes a predetermined activation code for activating decoder (570) of controller (540) of receiver (500) and subsequently one or more color zones (110, 120, 130 and/or 140) of lighting device (100). Transmitter (600) is powered by emergency vehicle's (600) electrical system.

In accordance with a preferred embodiment of the present invention, the activating signal broadcast from transmitter (606) carried by a fire truck (600) or ambulance (600) to receiver (500) activates first relay (200) and/or color zones (110 and 120), and optionally, third relay (204) and/or color zone (140). The activating signal broadcast from transmitter (606) carried by a police vehicle (600) to receiver (500) activates second relay (202) and/or color zones (120 and 130), and optionally, third relay (204) and/or color zone (140). In other select preferred embodiments and depending predetermined parameters, receiver (500) can be provided with more than three relays for controlling the flashing of the color zones of lighting device (100).

Within the scope of the present invention, activation of receiver (500) does not alter the normal operation of the commercially available traffic light configuration associated with road intersection (60). Instead, the present invention is capable of warning pedestrian and vehicular traffic in proximity of intersection (60) of the imminent approach of emergency vehicle (600) while the normal operation of the commercially available traffic light configuration associated with road intersection (60) remains unaltered.

Depending on preselected parameters, such as urban or rural environments, the signal transmitted by transmitter (606) of approaching emergency vehicle (600) activates receiver (500) when emergency vehicle (600) is within a preselected distance of receiver while receiver (500) is deactivated after emergency vehicle (600) has cleared intersection (60) and has travelled a preselected distance away from receiver (500). In select preferred embodiments of the present invention, transmitter (606) can include a manual override for deactivating transmitter (606) after emergency vehicle (600) has cleared intersection (60).

Having disclosed the invention as required by Title 35 of the United States Code, Applicants now pray respectfully that Letters Patent be granted for their invention in accordance with the scope of the claims appended hereto.

What is claimed is:

1. A visible warning system for a road intersection, wherein said visible warning system is capable of indicating an emergency vehicle is proximate a commercially available traffic light configuration controlling pedestrian and vehicular traffic associated with said road intersection; said visible warning system comprising:
a) a plurality of LED units positioned about said road intersection and visible to said pedestrian and vehicular traffic, wherein said LED units:
i) on activation, flash visible warnings comprising at least two distinct colors for identifying a specific type of said emergency vehicle and/or a different color from said at least two distinct colors for indicating said visible warning system is activating; and
ii) are powered by a power supply also supplying said commercially available traffic light configuration;
b) a transmitter carried by an emergency vehicle and powered by said emergency vehicle's electrical system, wherein, upon activation of said transmitter, transmission of a single preselected FCC approved analog frequency carrying a predetermined activation code is broadcast away from said emergency vehicle, and wherein said classification of said emergency vehicle determines said predetermined activation code;
c) a receiver powered by said power supplying said commercially available traffic light configuration and/or a solar panel and an energy storage unit combination, wherein said receiver is synchronized to said single preselected FCC approved analog frequency and operates independently of said commercially available traffic light configuration such that said receiver does not alter operation of said commercially available traffic light configuration and said commercially available traffic light configuration does not alter operation of said receiver, wherein said receiver comprises:
i) a weather resistant housing;
ii) an antenna for detecting as little as about 0.2 millivolt associated with reception of said single preselected FCC approved analog frequency;
iii) a first relay for activating said plurality of LED units to flash in a first mode, wherein said first mode includes a first color and a second color;
iv) a second relay for activating said plurality of LED units to flash in a second mode, wherein said second mode excludes either said first color or said second color and utilizes a third color;
v) a threshold determiner preventing activation of any of said relays until said emergency vehicle's transmitter has reached a preselected distance from said receiver;
vi) optionally, a third relay for activating said plurality of LED units to flash a third mode comprising a different color than said first mode or said second mode; and
vii) a controller energizing one or more of said relays on detection of said predetermined code and after a predetermined threshold of potential associated with said single preselected FCC approved analog frequency radio frequency broadcast by said emergency vehicle's transmitter is exceeded; and
d) one or more lines connecting said controller to each of said plurality of LED units.

2. The invention of claim 1, wherein LED units are positioned on fixtures associated with said commercially available traffic light configuration.

3. The invention of claim 3, wherein said emergency vehicle's transmitter is capable of causing said receiver to energize one or more of said relays from a distance of up to about 305 meters from said receiver.

4. The invention of claim 3, wherein said single preselected FCC approved analog frequency comprises about 433 megahertz.

5. The invention of claim 4 further comprising means for energizing one or more of said relays for about two seconds after said emergency vehicle's transmitter's radio frequency transmission has ceased to activate said controller.

6. A visible warning system capable of generating a multimodal visible flash to warn pedestrians and vehicles that an emergency vehicle is approaching an intersection; said visible warning system comprising:
a) a plurality of lighting devices positioned about said intersection with a commercially available traffic light configuration, wherein each of said lighting devices comprises at least three zones of lights having distinct hues and is powered by a power supply supplying said commercially available traffic light configuration, and wherein on activation, said lighting devices flash at least two distinct hues for identifying a specific type of said emergency vehicle;
b) a transmitter carried by an emergency vehicle and powered by said emergency vehicle's electrical system, wherein, upon activation of said transmitter, transmission of a single preselected FCC approved analog frequency carrying a predetermined activation code is broadcast away from said emergency vehicle, and wherein said classification of said emergency vehicle determines said predetermined activation code;
c) a receiver powered by said power supplying said commercially available traffic light configuration and/or a solar panel and an energy storage unit combination, wherein said receiver is synchronized to said single preselected FCC approved analog frequency and operates independently of said commercially available traffic light configuration such that said receiver does not alter operation of said commercially available traffic light configuration and said commercially available traffic light configuration does not alter operation of said receiver, wherein said receiver comprises:
i) a weather resistant housing;
ii) an antenna for detecting as little as about 0.2 millivolt associated with reception of said single preselected FCC approved analog frequency;
iii) a first relay for activating said plurality of lighting devices to flash a first hued zone of and a second hued zone;
iv) a second relay for activating said plurality of lighting devices to flash a third hued zone and either said first hued zone or said second hued zone;
v) optionally, a third relay for activating said plurality of lighting devices to flash a hued zone other than said first, second or third zones; and
vi) a controller energizing one or more of said relays on detection of said predetermined code and after a predetermined threshold of potential associated with said single preselected FCC approved analog frequency radio frequency broadcast by said emergency vehicle's transmitter is exceeded; and
d) one or more lines connecting said receiver to each of said lighting devices.

7. The invention of claim 6, wherein said lighting devices are positioned on fixtures associated with said commercially available traffic light configuration.

8. The invention of claim 7 further comprising a threshold determiner preventing activation of any of said relays until said emergency vehicle's transmitter has reached a preselected distance from said receiver.

9. The invention of claim 8, wherein said emergency vehicle's transmitter is capable of causing said receiver to energize one or more of said relays from a distance of up to about 305 meters from said receiver.

10. The invention of claim 9, wherein said plurality of lighting devices comprises LED units.

11. The invention of claim 10, wherein preselected FCC approved analog frequency comprises about 433 megahertz.

12. A visible warning system associated with a commercially available traffic light configuration controlling pedestrian and vehicular traffic about an intersection, wherein said visible warning system is capable of generating multimodal visible flashes to warn said pedestrian and vehicular traffic that an emergency vehicle is approaching said intersection; said visible warning system comprising:
a) a plurality of colored lights units positioned on one or more fixtures of said commercially available traffic light configuration, wherein said plurality of colored lights units are additional to any lighting device customarily accompanying said commercially available traffic light configuration;
b) a transmitter carried by an emergency vehicle and powered by said emergency vehicle's electrical system, wherein, upon activation of said transmitter, transmission of a single preselected FCC approved analog frequency carrying a predetermined activation code is broadcast away from said emergency vehicle, and wherein said classification of said emergency vehicle determines said predetermined activation code;
c) a receiver powered by said power supplying said commercially available traffic light configuration and/or a solar panel and an energy storage unit combination, wherein said receiver is synchronized to said single preselected FCC approved analog frequency and operates independently of said commercially available traffic light configuration such that said receiver does not alter operation of said commercially available traffic light configuration and said commercially available traffic light configuration does not alter operation of said receiver, wherein said receiver comprises:
i) a weather resistant housing;
ii) a controller for detecting said predetermined activation code such that after a predetermined threshold of potential associated with said single preselected FCC approved analog frequency radio frequency broadcast by said emergency vehicle's transmitter is exceeded said controller activates said plurality of colored lights units to flash a first predetermined pattern or a second predetermined pattern, wherein said predetermined flashing patterns are determined by said predetermined activation code, and
d) one or more lines connecting said controller to each of said colored light units.

13. The invention of claim 12, wherein each said colored lights units comprises zones of lights of distinct hues.

14. The invention of claim 13 further comprising a threshold determiner preventing activation of any of said colored lights until said emergency vehicle's transmitter is within a preselected distance from said receiver.

15. The invention of claim 14, wherein said first flash pattern comprises a first distinct hue and a second distinct hue and said second flash pattern comprises a third distinct hue and either said first hue or said second hue.

16. The invention of claim 15, wherein said controller activates said plurality of colored lights units to flash a third predetermined pattern comprising a hue that is distinct from said first, second and third hues.

17. The invention of claim 16, wherein said plurality of color lights units devices comprises LED units.

18. The invention of claim 17, wherein said emergency vehicle's transmitter is capable of causing said receiver to energize one or more of said relays from a distance of up to about 305 meters from said receiver.

19. The invention of claim 18, wherein preselected FCC approved analog frequency comprises about 433 megahertz.
